(19) United States
(12) Patent Application Publication
(10) Pub. No.: US 2013/0179388 A1
(43) Pub. Date: Jul. 11, 2013

(54) Method, System and Program Product for Intelligent Prediction of Industrial Gas Turbine Maintenance Workscope

(71) Applicants: Anurag Agarwal, Bangalore (IN); Harish Agarwal, Cincinnati, OH (US); Michael E. Graham, Niskayuna, NY (US); Anurag Kasyap Vejjupalle Subramanyam, Niskayuna, NY (US); Brock E. Osborn, Niskayuna, NY (US)

(72) Inventors: Anurag Agarwal, Bangalore (IN); Harish Agarwal, Cincinnati, OH (US); Michael E. Graham, Niskayuna, NY (US); Anurag Kasyap Vejjupalle Subramanyam, Niskayuna, NY (US); Brock E. Osborn, Niskayuna, NY (US)

(21) Appl. No.: 13/344,180

(22) Filed: Jan. 5, 2012

(51) Int. Cl. G06N 5/02

(52) U.S. Cl. 706/47

(57) ABSTRACT

A computer-implemented maintenance/repair workscope development tool uses one or more sources of gas turbine engine/fleet operational condition data, gas turbine engine/fleet historical data and gas turbine engine/fleet specific information, including other historical, statistical and maintenance/engineering records data to develop a recommended maintenance/repair workscope. A method, system and program product are described for producing a recommended maintenance/repair workscope for individual machines and/or machines on a fleet level. Relevant domain knowledge/information models along with appropriate application rules defining maintenance/repair requirements are predetermined and maintained in a network accessible database/repository. A rules/reasoner engine is used to develop logical inferences and make intelligent workscope choices based upon user input situational data, operational condition data stored in data/information databases and the predetermined knowledge/information models and rules. A disclosed non-limiting example workscope prediction/recommendation tool develops quantitative recommendations for the type of work needed to be performed to an individual gas turbine engine or an entire fleet.

The technology disclosed herein relates generally to an approach towards developing a web-based or communications network based intelligent repair/maintenance workscope recommendation tool, at least in part, enabled through the use of computer implemented knowledge/information domain modeling and one or more semantic modeling application design languages. More specifically, the disclosed technology relates to a computer-implemented workscope recommendation/prediction tool that uses information modeling and semantic web technologies for producing workscope recommendations for complex machinery and, more particularly, to a network-based platform independent method, system and program product for producing a recommended/predicted workscope for an individual gas turbine engine or a plurality of turbine engines on a fleet basis. This can be applied to other power generating equipments as Steam Turbine or Wind Turbine.

### BACKGROUND

Heavy-duty industrial gas turbine engines and other complex, safety-critical machines are inspected and repaired on a routine basis. Routine inspections are typically performed at preselected times, such as after a preselected number of operational hours or operational cycles. At these times, the engine or machine may need to be taken out of service, disassembled as necessary, inspected as necessary, and repaired as necessary. This process, conventionally termed a maintenance procedure, is typically a time consuming and costly process—especially since it requires an outage of the equipment to implement.

In some cases, the repair of one or more component performed during a maintenance procedure may include any one of several possible workscopes. For example, the component may require only a light cleaning or it may instead require a major repair. In extreme cases the component may need to be scrapped and replaced by a new version of the same component. Other gradations of such maintenance and repairs might also be needed. Upon disassembly of an engine, the turbine components are inspected and depending upon its individual condition, each turbine component may be cleaned only, repaired by welding, recoating, or other process, or replaced if the turbine component is too damaged to be readily repaired or not economical to repair.

Maintenance procedures for a gas turbine engine may typically be performed many times over its usable life. Conventionally, decisions as to what repairs are performed on each component at each shop visit are made primarily on the basis of technical criteria or as per generalized maintenance procedure. Although it is known to develop a maintenance procedure workscope based on previous outages and certain technical criteria, such workscopes do not take into account other relevant and important information such as, for example, field engineering expert knowledge and experience, information from manufacturer's notices/bulletins and operational directives, customer assistance records and other similar sources of current and historical operational information and data. Moreover, conventional workscope development tools and techniques are not known to use computer modeling to evaluate or consider statistical risks of unplanned outage. Conventional workscope development tools and techniques are also not known to utilize machine/component based operational models or apply physics-based failure modeling of individual machine components, perform statistics-based risk-of-failure assessments for the system or perform or use other potentially relevant stochastic models and tools for evaluating acquired historical and situational information/data in the formulation of a workscope. Conventional workscope development tools and techniques are also not known to possess any inherent intelligence or decision making capacity based on the results of performed stochastic analysis and computer modeling. In addition, conventional workscope development tools are not known to be network or web-based nor are they capable of autonomously acquiring or accessing historical and operational data/information from a plurality of network or web-based facilities. Consequently, there is a need for computer network or web-accessible workscope development tools and/or applications which exhibit all or at least some of the above mentioned features to provide machine/equipment owners and operators with a workscope product that is not only more accurate than a conventionally produced workscope but is also effectively proactive or predictive in its recommendations.

There is also a need for workscope development tools and techniques that adopt a more stochastic approach to workscope development so as to provide machine/equipment owners/operators with a recommended workscope which is derived, for example, using stochastic and statistics-based data models using a mixture of empirical and semi-empirical data. There is also need for computer network or web-based workscope development tools capable of accessing and using historical and operational data/information from network or web-based storage facilities. In addition, there is a need for computer network or web-based intelligent workscope development tools for gas turbine engines capable of evaluating and/or considering, for example, the risk of occurrence of unplanned outages either on an individual component, engine or engine fleet basis and which produce a predicted/recommended workscope output based on such stochastic evaluations. Moreover, a need exists for an intelligent computerized network-accessible or web-based tool for producing a recommended workscope for gas turbine engine and fleet maintenance/repair procedures that can inform when to perform maintenance procedures and which particular maintenance procedures or repairs to perform by evaluating, among other things, historical component failures and physics-based component failure modes so as to result in a reduction in the occurrence and number of costly unplanned outages. Having a stochastic-based workscope prediction tool as such would greatly assist in financial planning for maintenance/repair and, among other things, in the assessment of labor and supply requirements associated with the repair and long term maintenance of a particular gas turbine engine or an entire engine fleet or, for that matter, most any other type of complex machinery. In this regard, the presently disclosed method and program product for an intelligent workscope development tool fulfills most or all of the above recited needs, and further, provides other related practical benefits and advantages over existing conventional workscope analysis/development tools and methods.

The approach toward developing a web-based or communications network-based intelligent repair/maintenance workscope recommendation tool that is described herein is enabled, at least in part, through the use of computer implemented domain knowledge/information modeling, using one or more conventional semantic modeling languages and a set of inference rules, such as for example, OWL, SADL, SWRL, Jena/Pellet, etc. Conventional software rules/reasoner engines are well known. A semantic reasoner, reasoning engine, rules engine, or simply a reasoner, is a piece of software able to infer logical consequences from a set of asserted facts or axioms. The notion of a semantic reasoner generalizes that of an inference engine, by providing a richer set of mechanisms to work with. The inference rules are commonly specified by means of an ontology language, and often a description language. A rules/reasoner engine may be implemented using SWRL or, for example, Pellet (an open-source Java OWL DL reasoner) or the Jena rules framework (an open source semantic web framework for Java which includes a number of different semantic reasoning modules) to provide the reasoning analysis capability for developing various conclusions from the input data/information and semantic models.

### BRIEF DESCRIPTION

The non-limiting example system, method and program product disclosed herein has the technical effect of providing a computer implemented workscope recommendation/prediction tool which uses knowledge/information domain modeling and semantic web technologies to produce improved workscope recommendations for complex machinery, and more particularly, for producing an improved workscope recommendation for a particular individual gas turbine engine or for turbine engines on a fleet basis. The disclosed non-limiting example computer-implemented method, system and program product for a workscope recommendation/prediction tool described herein is contemplated to employ the use of one or more predetermined knowledge/information domain models, a conventional semantic application design language, one or more logical inference rules, machine/component operational data derived using one or more conventional stochastic analysis processes, conventional physics-based component failure analysis models, and a conventional rules/reasoner engine to analyze user input or otherwise acquired situational, historical, empirical and semi-empirical data concerning a specific gas turbine engine or a fleet of engines with the objective of producing a recommended workscope in the form of a document or readable display as a tangible, useful output for end-user customers/owners/operators of gas turbine engines. Moreover, the non-limiting example method and program product implementation described herein provides certain practical commercial advantages in producing a tangible useful result in the form of a recommended repair/maintenance workscope (e.g., in the form of a document or a display) which, being stochastically-based, significantly reduces the occurrences of costly unplanned outages due to component failures, among other benefits, and thus provides tangible improvement over workscopes developed by other conventionally known means, methods and approaches.

In a non-limiting example implementation of the workscope recommendation/prediction tool disclosed herein, an intelligent workscoping tool is provided which uses Semantic Models to capture and use gas turbine engine structure, technical information and service directive implications, and expert knowledge. Information about a specific engine, such as build requirements and life-limited part (LLP) cycles and/or operating hours, is collected or acquired from various knowledge/information sources and then provided or made available to a network connected computer or web server which implements the workscope generating method described in detail herein. The generated workscope is then provided or made available via the network to interested end users for review or resubmission. For example, in one example implementation, a sales or shop user may be able to override certain conclusions/recommendations because of additional knowledge/information which he or she alone may have and may submit that information with a request for an updated recommendation. This information from the skilled expert is captured in the system and used for future engine workscope recommendations for accurate predictions.

As mentioned above, the inventors contemplated use of a semantic modeling language to make semantic modeling more accessible to domain experts (e.g., experts knowledgeable in the domain in gas turbine engine operation, repair and maintenance). In the non-limiting example implementation disclosed herein, a known semantic modeling language called Semantic Application Design Language (SADL) is used. SADL is a controlled-English language with an Eclipse-based authoring environment for building rich formal models and adding layers of domain-specific rules. Models are translated to OWL (a well known conventional web ontology language) and application rules are translated to the Semantic Web Rule Language (SWRL) or to Jena Rules. A reasoner/rules engine is then able to draw inferences from both the logical structure of the model and from the domain rules. When situation-specific data is combined with the model or models, the output is the implications of the document for the particular situation.

For the non-limiting example implementation of the workscope recommendation/prediction tool disclosed herein, the SADL language and SADL-IDE are used to build models which are stored as SADL files and as OWL and Rule files. These files may be managed in a source control repository such as, for example, CVS (Concurrent Versioning System—a well known client-server free software revision control system in the field of software development). A selected reasoner/rule engine may be used to exercise and test models in the IDE. Once a set of models is ready for deployment as part of an application, the OWL and Rule files can be tagged for release and moved to a server environment where they are used by a reasoner/rule engine to receive instance data, infer results, and respond to queries from clients. The inventors contemplate that the intelligent workscoping tool described herein will be capable of modeling several engine lines and incorporating thousands of inference rules. The inventors also contemplate that the rules will be authored by experts knowledgeable in the field and can be easily generated programmatically using SADL with an intuitive and robust representation. The inventors also contemplate that the disclosed approach will facilitate lifecycle maintenance of the knowledge base as more engines types are added and engine technology evolves.

Conventionally, most complex industrial machine/machinery may be modeled in terms of major modules, minor modules, subassemblies, and constituent parts. For illustrative purposes herein, a gas turbine engine is used as an example of a type of complex machine for which the workscope recommendation/prediction tool described herein is particularly applicable. It is emphasized, however, that the non-limiting example workscope recommendation/prediction tool implementation disclosed herein is generally applicable to any complex machine/machinery comprising major and/or minor modules or assemblies and constituent subassemblies and individual parts for which historical/empirical operational profile data can be obtained and accumulated.

The illustrative non-limiting example computer process and program product disclosed herein produces a recommended future maintenance workscope for a heavy-duty gas turbine engine/engine fleet by using a statistical modeling approach based upon a combination of empirical data, semi-empirical data, statistical modeling and historical machine/fleet operational knowledge. Data is identified and collected from a variety of sources and resources for a particular gas turbine engine or engine fleet. The workscope recommendation/prediction tool includes a Workscoping Rules/Reasoner engine which utilizes the acquired/accumulated data in combination with data/information developed from the use of specific component operational and risk-of-outage models to develop a recommended workscope. For example, data input to the Workscoping rules/Reasoner engine may be derived from one or more, among others, of various conventional fleet level unplanned outage reliability models, fleet level component scrap models, fleet or engine specific damage evolution models, a compressor stator quadrant discriminate analytical model, borescope inspection reports, planned inspection/repair/replace interval data, engine operational conditions, engine historical outage workscope information, component or section health estimates from remote monitoring and diagnostics data, as well as any pre-developed/predetermined business and overhaul process rules for workscope decision making.

One non-limiting example implementation discloses a method and program product for producing a workscope for individual gas turbine engines and/or for engines on a fleet level. In the non-limiting example disclosed herein, the workscope recommendation/prediction tool may use, among other things, semi-empirical component/engine specific meta-models, component/engine specific operating conditions, engine historical outage workscopes, and recommended inspection interval data. The workscope recommendation/prediction tool may also compute, among other things, the probability over time of individual engine part failure and compare this to an acceptable/allowable limit for each part. One or more predetermined knowledge/information domain models along with a set of predetermined logical inference rules are utilized by a rules/reasoner engine along with operational data obtained from one or more databases and end-user input operational situation data to provide quantitative recommendations for the type of work needed to be performed. For example, a recommended workscope may be developed for one or more types of planned outages such as, for example, a forthcoming combustion inspection, turbine inspection or a major general overall engine inspection.

In the disclosed implementation, semantic information modeling is used to capture, among other things, historical and empirical gas turbine operational data, semi-empirical physics-based component failure models and statistical risk-of-outage assessment models. In the particular non-limiting example implementation described herein, captured information is categorized into three general source classes: Engine Operational Condition Data, Fleet Historical Data and Engine Specific Information (FIG. 2). SADL Models, OWL Models, SWRL and Jena Rules are well known conventional open source modeling, semantic analysis and rules/reasoning engine software. These conventional software tools and data sources are used as a basic platform from which to develop the workscoping models (e.g., using different physics/stistical models and relevant data from these different sources) and layer domain and business rules on top of these models. A conventional rules/reasoner engine may then be used to implement specific pre-developed SWRL or Pellet or Jena rules to provide the reasoning analysis capability for developing conclusions from the acquired engine/fleet data. In the non-limiting example implementation disclosed herein, a method, system and program product is described for producing a recommended workscope based upon, among other things, stochastic modeling and risk-of-failure analysis. The recommended/predicted workscope produced thereby may then be used by the machinery owner/operator to make better decisions on the planned workscopes for valuable equipment assets based on the operating profile(s) of the equipment itself. Among other things, the workscope produced may, for example, enhance an gas turbine owner/operator's ability to minimize the possibility of occurrence of any extra or emergent work during a planned equipment outage and allow a more accurate estimate of future maintenance costs, labor, supplies and outage time associated with particular individual gas turbine engines or an entire engine fleet and/or other complex machinery.

Although the illustrative non-limiting example computer implementation of the Workscoping rules/Reasoner engine disclosed herein is generally applicable toward implementing an efficient workscope prediction tool for producing a recommended workscope for gas turbine engines, the described method and program product it is not limited solely to the technology of gas turbine engines but may also be applicable to other types of complex machinery requiring a routine of periodic inspection, maintenance and repair.

The methods and systems described herein can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning). As described herein and as will be appreciated by one skilled in the art, the non-limiting examples described herein may be configured as a system, method, or computer program product. Accordingly, the non-limiting example embodiments as disclosed herein may be comprised of various means including entirely of hardware, entirely of software, or any combination of software and hardware. Furthermore, the non-limiting example embodiments as disclosed herein may take the form of a computer program product on a computer-readable storage medium having computer-readable program instructions (e.g., computer software) embodied in the storage medium. Any suitable non-transitory computer-readable storage medium may be utilized including hard disks, CD-ROMs, optical storage devices, or magnetic storage devices.

The processing of the non-limiting example methods and systems disclosed herein can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

The non-limiting example embodiments disclosed herein are described with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks. Accordingly, blocks of the block diagrams and flowchart illustrations disclosed herein support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### BRIEF DESCRIPTION OF THE DRAWINGS

The block diagrams in the figures below do not necessarily represent an actual physical arrangement of the example system, but are primarily intended to illustrate major procedural aspects and method steps in convenient functional groupings so that the non-limiting illustrative exemplary implementation presented herein may be more readily understood. The above described features and other aspects and advantages will be better and more completely understood by referring to the following detailed description of exemplary non-limiting illustrative implementations in conjunction with the drawings of which:

FIG. 1 is non-limiting example computer network arrangement in which the disclosed workscope recommendation/prediction tool may be implemented;

FIG. 2 a high-level functional block diagram illustrating a non-limiting example of gas turbine engine information source categories/classes and processing performed by the disclosed workscope recommendation/prediction tool;

FIG. 3 is a high-level process flow diagram illustrating non-limiting example processing operations performed by the disclosed workscope recommendation/prediction tool;

FIG. 4 is an information flow diagram illustrating a non-limiting example of the workscope development engine and the exchange of models, rules and other information and data from end-users and a data repository;

FIGS. 5A and 5B are generalized examples of SADL domain knowledge/information semantic modeling language models and rules; and

FIG. 6 is one non-limiting example format for a printout or display screen output generated by the workscope recommendation/prediction tool described herein.

### DETAILED DESCRIPTION

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, smart meters, smart-grid components, SCADA masters, distributed computing environments that comprise any of the above systems or devices, and the like.

In anticipation of a maintenance procedure to be performed on a particular article/machine or fleet of machines, a “workscope” is first developed. Basically, a “workscope” is a task or list of tasks of defined extent and nature. In the maintenance of gas turbine engines, maintenance procedures are typically performed in discrete blocks at specific inspection points of operational hours. For example, all of the turbine vanes, as well as the other engine components, are usually checked when the engine is taken out of service for planned routine inspections. Workscopes of various types for planned inspection/maintenance outages are typically set forth in maintenance manuals that are carefully followed by the technicians who perform the maintenance procedures. An example, which is mentioned here only for illustration and not by way of limitation, would be the case of a workscope for a turbine vane component of a gas turbine engine wherein the workscope calls for cleaning one or more turbine vane parts of deposited hydrocarbons and other residue; a second, more extensive workscope might include the removing of coatings on the airfoil of one or more turbine vane parts, weld repairing of cracks and other areas at where there has been a loss of metal, and performing a recoating of the turbine vane parts; a third workscope might involve the scrapping of one or more turbine vanes and replacement by a newly manufactured turbine vane.

In practice, workscopes for planned inspection/maintenance outages are not limited to only turbine vanes or to a particular gas turbine or machine, but in fact may be developed for an entire fleet of gas turbines or other machines. Such planned inspection/maintenance outages will have an associated workscope and it can be expected that a gas turbine engine will have multiple planned outages for routine inspection/maintenance as well as a certain amount of unplanned outages due to component failures during its service life. Such recommended or predicted workscopes each require different labor and supplies, and also have different associated monetary values in terms of repair time and cost both to the organization performing the workscope and to the organization paying for the workscope performed. Accordingly, stochastic and physics-based models are used by a workscope recommendation/prediction tool described herein to forecast part failures and optimize the workscope performed during planned inspection/maintenance outages so as to anticipate and reduce occurrences of unplanned outages and provide other benefits and advantages as described.

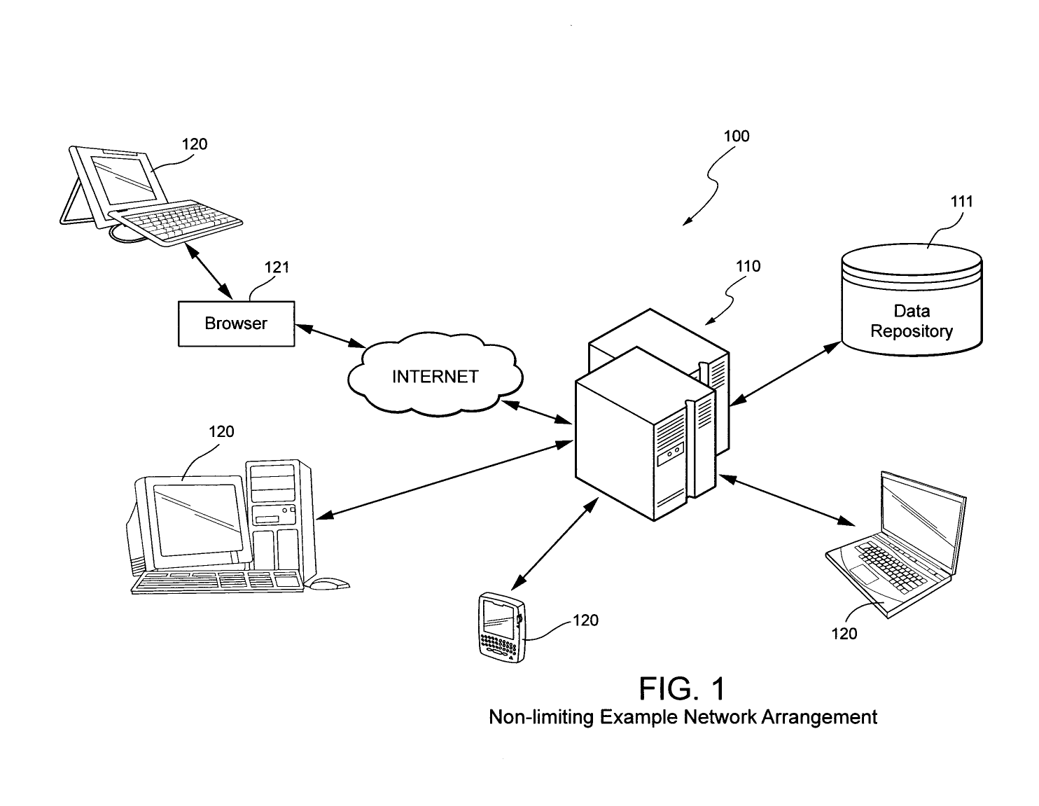

FIG. 1 is a schematic block diagram illustrating a non-limiting exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment. FIG. 1 schematically illustrates/suggests a non-limiting example computer network 100 having one or more Servers 110 on which the disclosed workscope recommendation/prediction tool may be implemented and accessed. However, operations performed by the workscope recommendation/prediction tool described herein are not limited to solely being implemented on a single computer/server or network or hardware arrangement as illustrated in FIG. 1. The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, smart meters, smart-grid components, SCADA masters, distributed computing environments that comprise any of the above systems or devices, and the like. Network 100 may include one or more user workstations/terminals 120 and at least one data repository or other data mass storage utility 111. One or more servers 110 of network 100 may also be connected to the Internet or another private/public WAN or LAN and may include widely distributed access points for providing access to the workscope recommendation/prediction tool via the workstations/terminals 120. The workstations/terminals 120 may be, for example and without limitation, conventional PC workstations connected to the server(s) 110 according to conventional networking mechanisms including, without limitation, wireless networking, or handheld data terminals (sometimes conventionally known as Personal Data Assistants or PDAs) that may in particular be connected to the server(s) 110 using conventional wireless data communication technology so as to provide mobile service personnel with network connectivity. Likewise, a portable tablet computer, or even simple keypads or touchscreen devices may also be used as user terminals 120. The use of portable or hand-held devices may be particularly useful for enabling service personnel to move freely about a facility while accessing workscope information (or for example, to facilitate movement about a machine while it is being serviced).

The computing devices such as user workstation/terminal devices 110 and 120 typically comprises a variety of computer readable media. Exemplary readable media can be any available media that is non-transitory and accessible by the computing devices 120 and comprises, for example and not meant to be limiting, both volatile and non-volatile media, removable and non-removable media. The system memory for devices 110 and 120 comprises computer readable media in the form of volatile memory, such as random access memory (RAM), and/or non-volatile memory, such as read only memory (ROM). User workstation/terminal devices 120 may include a conventional web-browser application 121 and/or other custom user interface for generally communicating and interacting with one or more servers 110 of computer network 100 to access the workscope prediction tool and/or workscope information. Although not explicitly indicated in FIG. 1, network 100 and workstation/terminal devices 120 may of course also include conventional computer peripherals such as printers (for example, for printing out a workscope form or document) and monitors or display devices (for example, for displaying a workscope). the user can enter commands and information into the computing device 108 via an input device (not shown). Examples of such input devices comprise, but are not limited to, a keyboard, pointing device (e.g., a “mouse”), a microphone, a joystick, a scanner, tactile input devices such as gloves, and other body coverings, and the like. User workstation/terminal devices 120 may also be used, for example, to enter individual machine or fleet identification information and any empirical or other acquired data for use by the workscope prediction tool, and to provide a display of a resultant workscope produced by the workscope prediction tool. Data storage repository 111, which may be centrally located or distributed across network 100, represents one or more data storage units or devices for storing and maintaining gas turbine engine configuration records and other historical and statistical information and data regarding individual engines and/or a fleet of engines. The information maintained in data storage repository 111 for a particular engine or fleet preferably includes at least certain current engine operational condition data, engine/fleet historical data and engine/fleet specific data. For example, information stored in data repository 111 may include, among other things, records of indicating an ID or serial number for each of the engines and an identification of the corresponding owner, listings and identifications of engine and fleet related historical documentation such as OEM Business Recommendations, Technical guidelines, technical recommendations to operate the equipment, Engine Specific technical issue during operation, inspection interval data, borescope inspection data and the like. Data repository 111 is also used to also store and make available via network 100 other information such as software and program data for implementing a variety of statistical risk assessment and/or physics-based models that may be used by the workscope prediction/recommendation tool.

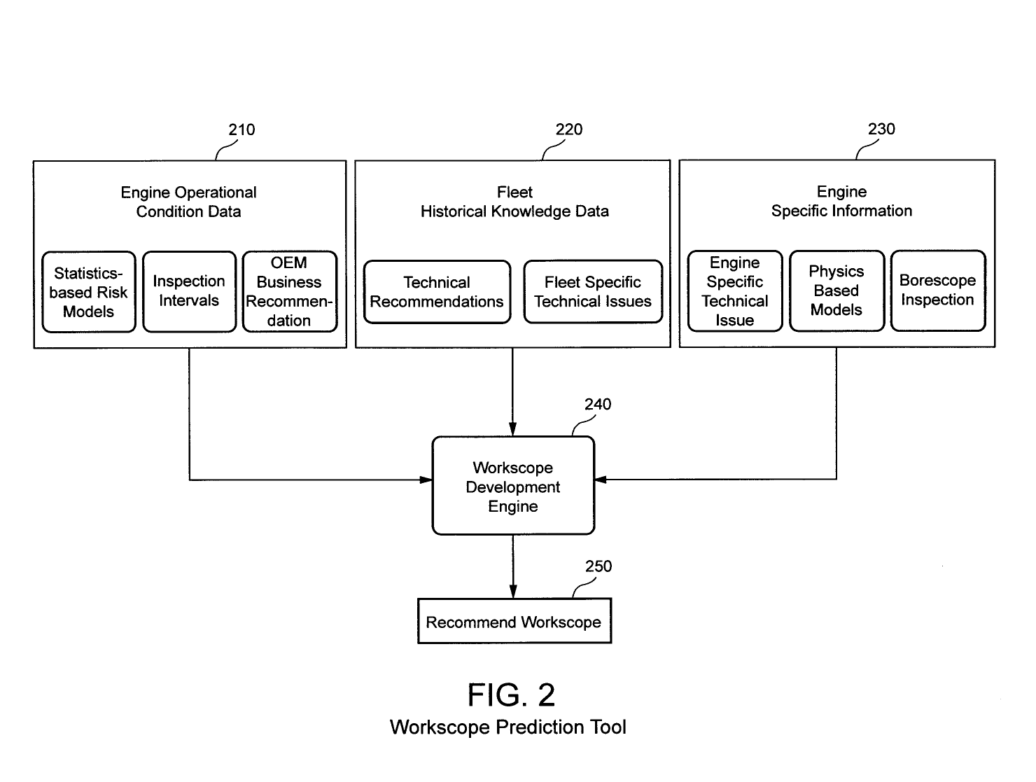

FIG. 2 shows a high-level functional block diagram for illustrating a non-limiting example of gas turbine engine information source categories/classes and processing performed by the disclosed workscope recommendation/prediction tool. As described above, information modeling techniques are used by domain experts (in this example, experts in the field/domain of gas turbine operation, maintenance and repair) to capture and use relevant data and information concerning an individual gas turbine engine and/or an entire engine fleet. For this example, relevant empirical and stochastic data and other information is obtained from a variety of sources including but not limited to monitored empirical operational data from gas turbine power generation plant sites, archived engine/fleet operational data records and computer-implemented stochastic and physics-based models such as used for calculating component risk-of-failure and/or conducting physics-based component failure analyses. For the particular non-limiting example describes herein, the relevant data and information is shown organized into three general categorical types: Engine Operational/Condition Data 210, Fleet Historical Knowledge Data 220 and Engine Specific Information 230.

Referring to FIG. 2, Engine Operational/Condition Data in block 210 includes, among other things, data generated using various proprietary and/or standard conventional computerized statistical models for computing risk-of-failure for specific gas turbine engine components, inspection interval data from historical records and other engine operational documentation such as OEM Business recommendations for instructing engine owners of approved maintenance practices and procedures. Fleet Historical data of block 220 would comprise data derived, for example, from archived Technical Recommendation concerning an engine/fleet and from other engine/fleet related historical documentation such as, for example, GE specific equipment related “ ” Fleet Specific Technical issues. Engine Specific Information block 230 may comprise data derived from Physics-based computer models of component failure modes, borescope inspection data and, for example, various customer-based sources such as data from specific Internet blogs and/or data from customer answer provisioning services such as Engine Specific Technical issue during operations stored on a server Workscoping Rules/Reasoner engine 240 then analyzes the data provided from one or more of these primary categories of empirical, historical and semi-empirical information and produces a recommended/predicted workscope in the form of a printed output or on a display at a user terminal 120 (FIG. 1).

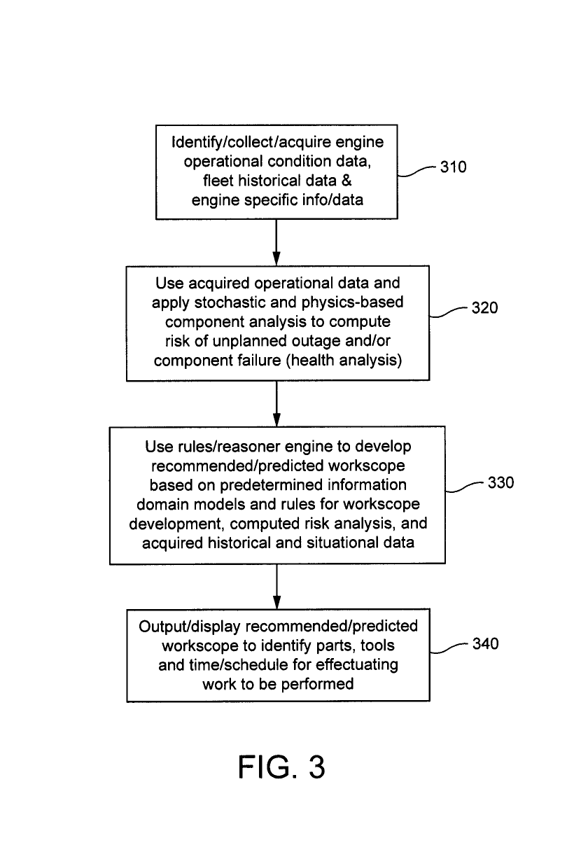

Referring now to FIG. 3, a process flow diagram is used to show a non-limiting example of basic overall high-level processing operations that are performed by the workscope recommendation/prediction tool to produce a workscope recommendation/prediction for a gas turbine engine or engine fleet. One skilled in the art would appreciate that a computer implemented process of the workscope recommendation/prediction tool disclosed herein is not necessarily limited to the specific algorithmic or stepwise process of FIG. 3. Moreover, the processing operations performed by the workscope recommendation/prediction tool are not limited to solely being implemented using the specific example hardware arrangement of FIG. 1 showing one or more network computer/server 110 accessible by user devices 120 connected to network 100. Initially, as indicated in process block 310, engine/fleet related empirical, historical and semi-empirical information is first identified, acquired and stored. Preferably, the acquisition, organization, updating and storing/archiving of this information is typically an ongoing, continuing process. One or more data repositories may be used for this purpose. After acquiring the relevant data, appropriate conventional stochastic risk-of-failure and physics-based component failure assessment models are applied, as indicated at block 320, to compute and generate data indicative of the risk of outage and component failure modes for the particular engine/fleet. Next, as indicated at block 330, computed risk analysis situational data along with the collected empirical, semi-empirical and historical engine component/fleet related data is provided to a workscoping Rules/Reasoner engine which develops a recommended workscope in accordance with predetermined knowledge/information models and rules concerning gas turbine engine maintenance and repair. This may also include specific knowledge models and rules applicable to a particular engine/fleet for which the workscope is intended. Then, as indicated at block 340, the workscoping Rules/Reasoner engine generates a recommended workscope for providing to an end-user/customer/owner as, for example, a display on a user terminal or printout. The workscope recommendation/prediction tool may also use the generated workscope output to generate and provide additional related information such as, for example, risk-of-failure and maintenance/repair recommendations broken down according to individual parts, repair statistics and limits for particular parts and/or categories of parts, recommended outage schedules and/or required tools and estimated outage time, among other things, needed for effectuating the recommended/predicted work to be performed.

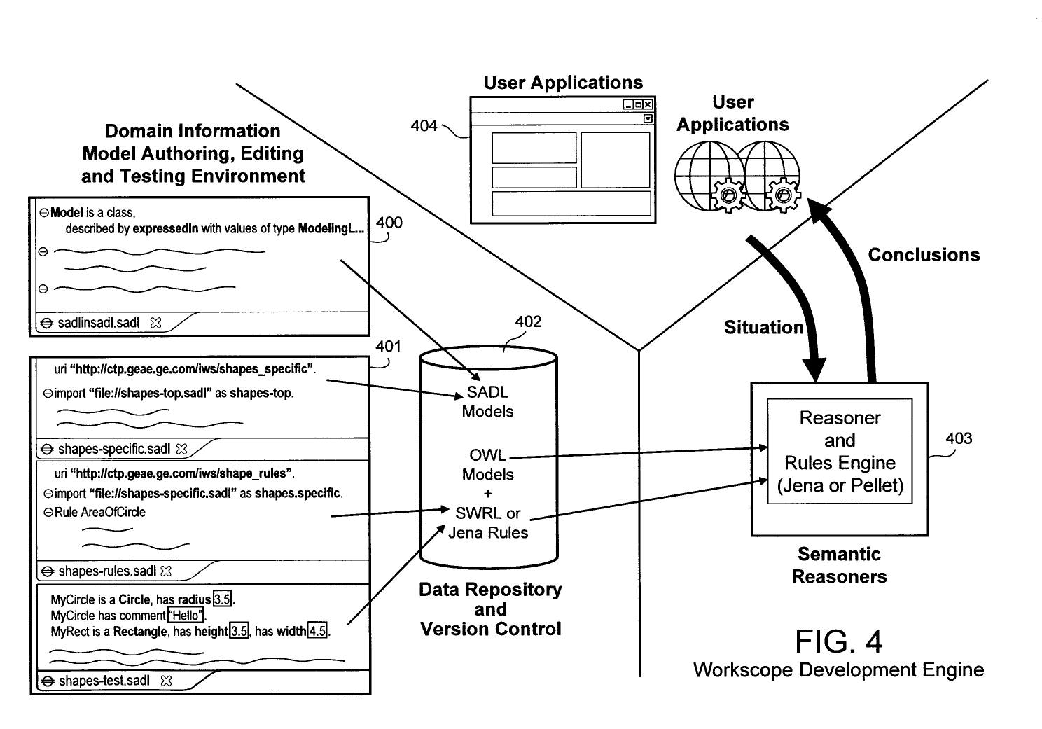

In FIG. 4, a conceptual functional diagram of the workscope development engine is shown for illustrating the general information flow and data exchange from a rules and domain model authoring environment to a data repository for storing and managing the domain knowledge/information models to the development and providing of a workscope conclusion to end-users by a rules/reasoner engine. Representative program listings 400 and 401 illustrate example Semantic SADL models and rules that are created by one or more domain experts from an authoring, editing and testing environment. For example, OWL and SADL models and SWRL or Pellet/Jena rules relevant to gas turbine engine maintenance and repair are preferably authored and tested by the appropriately skilled experts. These models and rules may then be stored and maintained/updated using one or more mass storage data repository 402 which is preferably made accessible via the Internet or other network communications to a server or computer supporting a reasoner/rules engine 403. In this example, particular SADL Models, OWL Models, SWRL, Pellet and Jena Rules (not explicitly disclosed herein) are predetermined or pre-developed in an appropriate Domain Information Model Authoring, Editing and Testing Environment, for example, by one or more persons with appropriate expertise in the knowledge/information domains of gas turbine operation, repair and maintenance. The various domain models and rules are then stored and maintained, for example, in a network accessible data repository/mass storage facility 402. One skilled in the art would appreciate that specific layer domain and business rules may also be developed and implemented on top of the gas turbine engine maintenance domain knowledge/information models. These knowledge/information domain models and rules are then provided to or made accessible for use by a semantic reasoner and rules engine 403 which applies the models and rules to data relevant to specific end-user applications/situations and the previously acquired engine/fleet condition, historical and engine specific data. The workscoping rules/reasoner engine 403 then develops a recommended workscope and produces a resultant output recommendation for an end-user who requested the workscope. The requesting of a specific workscope and the providing of appropriate situational information particular to a user may also be made at least somewhat customized and streamlined via the use of one or more computer or web-enabled user applications 404 (not explicitly disclosed herein) using conventional programming techniques and tools.

Although not explicitly illustrated in FIG. 4, the reasoner and rules engine 403 also receives and has access to acquired historical, stochastic and empirical data (FIG. 2) which may be stored and provided by one or more information storage resources such as repository 402 and which may be distributed across the Internet or other communications network. In this arrangement, reasoner and rules engine 403 may receive the appropriate gas turbine engineering/analyst expert-created SADL and OWL Models and SWRL or Jena Rules and any updates from data repository 402. In this manner, a workscope may be developed that is tailored to any particular gas turbine engine or fleet. As previously mentioned in the background discussion above, the software for authoring SADL Models, OWL Models, SWRL, Pellet and Jena Rules is well known and is provided open source via readily available Internet sources or through other conventional sources of semantic modeling language and reasoner/rules authoring software. One can appreciate that a gas turbine repair engineer/domain expert of ordinary skill in the art would be capable of authoring relevant semantic models and rules for a particular turbine engine or fleet of engines for which a workscope is desired without undo experimentation.

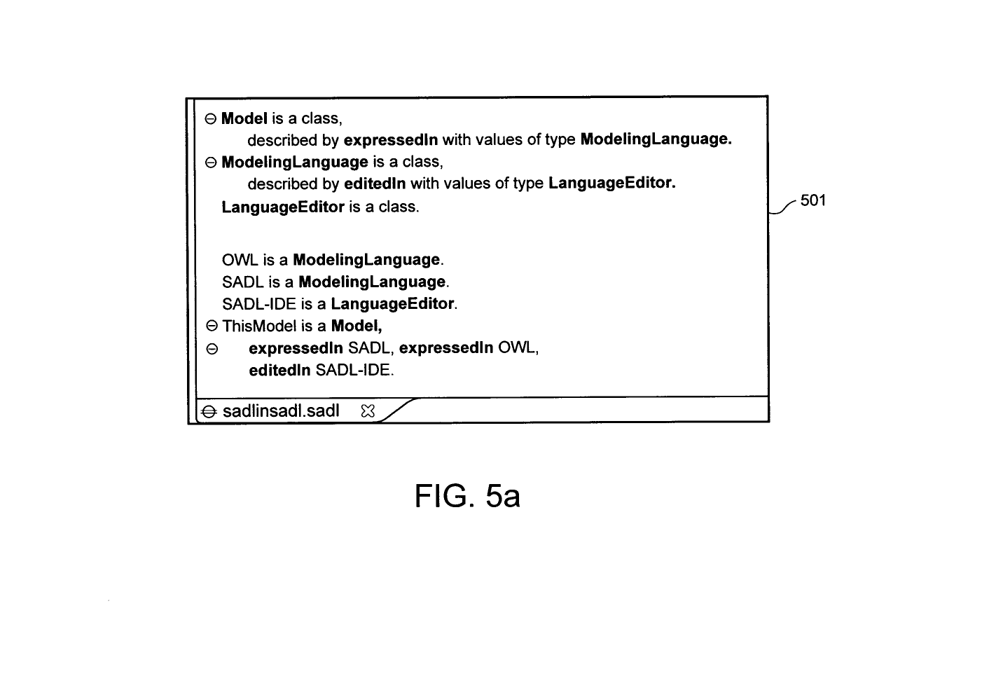

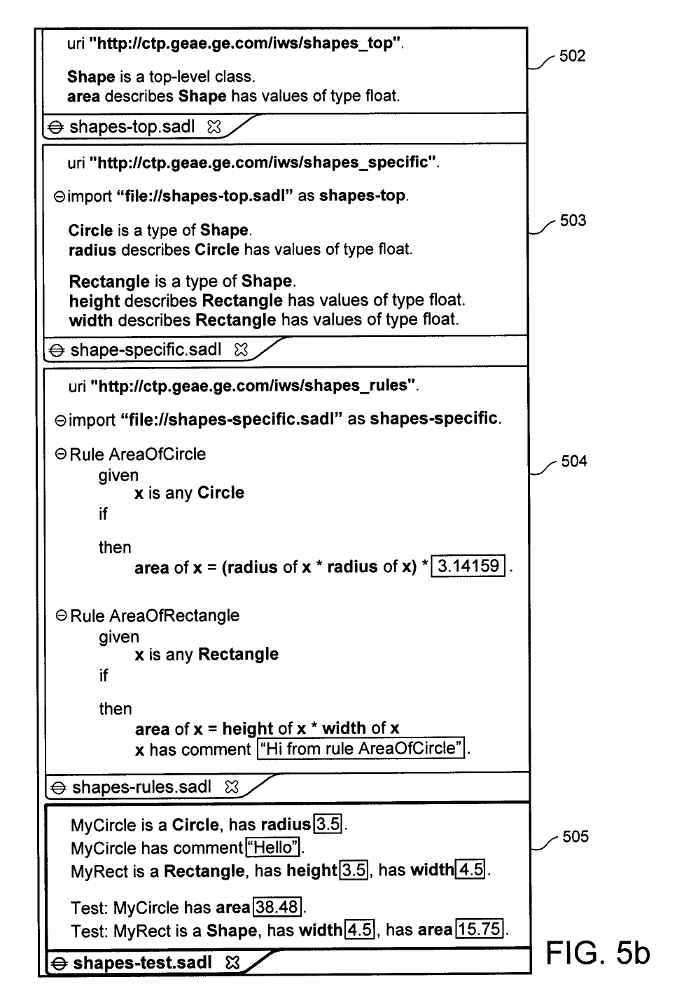

FIGS. 5a and 5b show some examples of semantic SADL language modeling and Rules. In FIG. 5a, block 501 shows a simple example of how information/knowledge about three semantic modeling languages could be modeled. Basically, using an appropriate semantic modeling language such as SADL, generic classes of things are first semantically defined and then members of those classes and their relationships are semantically described. Rules for setting inferences may also be added. In FIG. 5b, a second example shows how knowledge/information concerning different geometric shapes may be modeled using SADL. In block 502 a shape class is defined. In block 503, various types of shapes are defined and their relationships as described. In blocks 504 various rules are set forth defining inferences in applications of the models to specific data. In block 505, SADL is used to provide a simple test output of the models and rules of blocks 503 and 504. For a particular implementation of the workscope recommendation/prediction tool described herein, SADL models and rules of this sort (not explicitly disclosed herein) may be readily authored by one of ordinary skill in this art to model the domain of information/knowledge concerning gas turbine engine maintenance and repair.

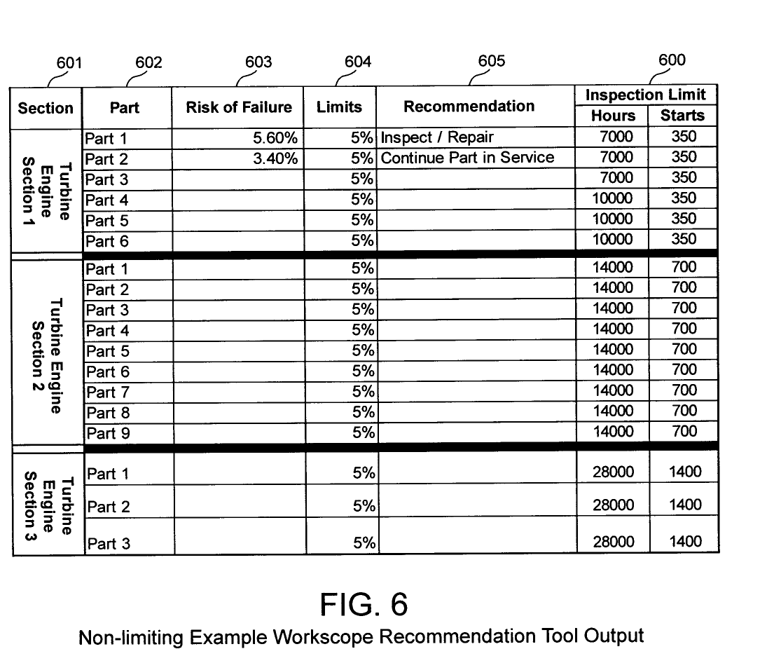

FIG. 6 shows one non-limiting example format for a printout/screen display output 600 that may be generated by the workscope recommendation/prediction tool disclosed herein. In this non-limiting example, the workscope output includes a sections column 601 for grouping workscope information relating to the different major operational sections of a gas turbine engine such as, for example, combustion section parts, compressor section parts, turbine section parts, etc. A parts column 602 lists specific turbine engine components and parts for each section. A calculated risk-of-failure column 603 provides the computed risk-of-failure statistics or percentages for each listed part. A limits column 604 may be used to specify margins of error or tolerance limits for each part. A recommendation column 605 is provided for providing a short statement of the recommended workscope for each listed part. For example, each listed part may be provided with a recommendation to “inspect”, “repair” or simply “continue same part in service”. Additional columns of information 606 may be used to specify such things as an operational use repair limit or other information relevant or useful for the assessment of particular parts or implementation of a particular workscope. For example, repair limit information may be specified for each individual part in terms of total operation hours or machine “Starts”. An output workscope listing may of course be organized and tailored according to the specific operational needs of the particular end-user and particular engine/fleet.

As described above, an implementation of the method disclosed herein may be in the form of computer-implemented process and/or program product for practicing those processes. An implementation may also be practiced or embodied in the form of computer program code containing instructions embodied in tangible media, such as floppy diskettes, CD ROMs, hard drives, or any other computer-readable storage medium, wherein when the computer program code is read and executed by a computer, the computer becomes an apparatus for practicing the disclosed process or method. An implementation may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is read and/or executed by a computer, the computer becomes an apparatus for practicing the disclosed process or method. When implemented on a general-purpose programmable microprocessor or computer, the computer program code configures the programmable microprocessor or computer to create specific logic circuits (i.e., programmed logic circuitry).

While a disclosed process and apparatus is described herein with reference to one or more exemplary embodiments, it will be understood by those skilled in the art that various changes may be made and equivalence may be substituted for elements thereof without departing from the scope of the claims. In addition, many modifications may be made to the teachings herein to adapt to a particular situation without departing from the scope thereof. Therefore, it is intended that the claims not be limited to the specific embodiments disclosed, but rather include all embodiments falling within the scope of the intended claims. Moreover, the use of the terms first, second, etc. and indicia such as (i), (ii), etc. or (a), (b), (c) etc. within a claim does not denote any order of importance, but rather such terms are used solely to distinguish one claim element from another.

The above written description uses various examples to disclose exemplary implementations, including the best mode, and also to enable any person skilled in the art to practice the invention, including making and using any devices or systems and performing any incorporated methods. The patentable scope of the invention is defined by the claims which follow, and may include other examples that occur to those skilled in the art. While an exemplary implementation has been described herein in connection with what is presently considered to be the most practical and preferred embodiment, it is to be understood that the claimed invention is not to be limited to the disclosed example embodiments, but on the contrary, is intended to cover various modifications and equivalent arrangements included within the spirit and scope of the appended claims.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Many modifications and other embodiments of the example implementation(s) set forth herein will come to mind to one skilled in the art to which these embodiments pertain having the benefit of the teachings, descriptions and the associated drawings presented herein. Therefore, it is to be understood that the example implementation(s) described herein are not to be limited to the specific examples or embodiments disclosed and that modifications and other embodiments are intended to be included within the scope of the appended claims. Moreover, although the descriptions and the associated drawings herein describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described herein are also contemplated as may be set forth in some of the appended claims. Although specific terms are employed herein, they are used in a generic and descriptive sense only and not for purposes of limitation.

What is claimed is:

1. A computer implemented method for producing a workscope for maintenance/repair of a machine or equipment, comprising:
storing one or more of machine/equipment operational condition data, machine/equipment historical operational data and machine/equipment specific information;
storing one or more predetermined domain information/knowledge models concerning said machine/equipment;
storing one or more predetermined rules defining workscope inference requirements for use by a computer implemented rules/reasoner engine in evaluating said machine/equipment operational condition data, machine/equipment historical operational data or machine/equipment specific information in accordance with said one or more domain information/knowledge models;
using a computer implemented rules/reasoner engine to compute a workscope recommendation based upon stored machine/equipment data and information, the predetermined domain information/knowledge models and the predetermined rules; and
providing the workscope recommendation for output to a printer or display device.

2. The method of claim 1 including steps for producing a repair/maintenance workscope recommendation for either an individual gas turbine engine or a plurality of engines on a fleet level, comprising:
acquiring one or more of gas turbine engine/fleet operational condition data, gas turbine engine/fleet historical data and gas turbine engine specific information;
storing one or more predetermined domain knowledge/information models concerning gas turbine engine/fleet operation, maintenance or repair;
storing one or more predetermined rules defining workscope inference requirements for use by a computer implemented rules/reasoner engine in evaluating the gas turbine engine operational condition data, gas turbine engine/fleet historical data and/or gas turbine engine specific information in accordance with the one or more of said domain knowledge models;
using a computer implemented rules/reasoner engine to compute a workscope recommendation based upon one or more of said acquired gas turbine engine/fleet data and information, the predetermined domain information/knowledge models and the predetermined rules; and
providing the workscope recommendation for output to a printer or display device.

3. The method of claim 2 wherein acquiring one or more of said engine/fleet operational condition data, engine/fleet historical data and engine specific information includes computing a stistical risk of unplanned outage using one or more of conventional stochastic risk analysis models or physics-based failure assessment models.

4. The method of claim 2 wherein said predetermined rules defining workscope inference requirements are based upon a predetermined set of SWRL or Jena rules.

5. The method of claim 2 wherein said one or more predetermined domain knowledge/information models comprise semantic application design language (SADL) constructs.

6. The method of claim 2 wherein said operational condition data, engine/fleet historical data and engine specific information is stored in one or more data storage devices or data repository, connected via the Internet or other communications network.

7. The method of claim 1 including steps for producing a repair/maintenance workscope recommendation for either an individual gas turbine engine or a plurality of engines on a fleet level, comprising:
acquiring and storing gas turbine engine operational condition data, gas turbine fleet historical data and gas turbine engine specific information in a data repository;
computing a statistical risk of unplanned outage using one or more of stochastic outage-analysis models or physics-based component failure models based upon one or more of said acquired gas turbine engine/fleet operational condition data, engine/fleet historical data and engine/fleet specific information; and
generating a gas turbine engine/fleet workscope output listing for printing or display based upon said computed statistical risk.

8. The method of claim 7 wherein a computer implemented rules/reasoner engine is used to develop a recommended workscope based at least in part upon said computed risk of unplanned outage.

9. The method of claim 8 wherein rules/reasoner engine uses a set of predetermined domain information/knowledge models and application rules defining maintenance/repair requirements for a gas turbine engine/fleet.

10. The method of claim 9 wherein said application rules comprise Jena rules or Semantic Web Rule Language (SWRL) constructs.

11. The method of claim 9 wherein said predetermined domain information/knowledge models comprise SADL constructs.

12. A computer-readable non-transitory tangible storage medium embodying one or more sequences of computer-executable processing instructions which, when executed by one or more computer processors or servers of an information exchange/communications network, perform operations for producing a recommended/predicted workscope for either an individual gas turbine engine or a plurality of engines on a fleet level, the processing instructions comprising:
a first instruction or sequence of instructions that cause a processor or server to provide access to one or more sources of gas turbine engine/fleet operational condition data, gas turbine engine/fleet historical data and gas turbine engine/fleet specific information;
a second instruction or sequence of instructions that cause a processor or server to provide access to one or more predetermined domain knowledge/information models concerning gas turbine engine/fleet operation, maintenance or repair;
a third instruction or sequence of instructions that cause a processor or server to provide access to one or more predetermined rules defining gas turbine engine/fleet maintenance or repair requirements; and
a fourth instruction or sequence of instructions that cause a processor or server to implement a rules/reasoner engine which evaluates said gas turbine engine/fleet operational condition data, gas turbine engine/fleet historical data and gas turbine engine/fleet specific information in accordance with said one or more domain knowledge/information models and said rules.

13. The medium of claim 12 further including instructions that cause a processor or server to display or print a workscope recommendation listing on a display device or printer device connected to said one or more computer processors.

14. The medium of claim 12 further including one or more SADL models.

15. The medium of claim 12 further including one or more SWRL rules.

16. A computer network based system for producing a repair/maintenance workscope recommendation for either an individual gas turbine engine or a plurality of engines on a fleet level, comprising:
one or more data storage facilities for storing one or more of machine/equipment operational condition data, machine/equipment historical operational data and machine/equipment specific information;
one or more data storage facilities for storing domain knowledge/information models concerning maintenance or repair of gas turbine engines and application rules; and
one or more servers connected via the network to said data storage facilities and running a reasoner/rules engine for evaluating one or more of gas turbine engine/fleet operational condition data, gas turbine engine/fleet historical data and gas turbine engine/fleet specific information in accordance with said one or more domain knowledge/information models and said application rules.

17. The system of claim 16 wherein the knowledge/information models comprise SADL models.

18. The system of claim 16 wherein the application rules comprise SWRL.

19. The system of claim 16 wherein the network is configured to acquire, store and distribute information concerning individual gas turbine engines or a fleet of engines, including gas turbine engine operational condition data, fleet historical data and engine specific information, and includes at least one server coupled to one or storage memory devices for storing one or more predetermined domain knowledge/information models concerning gas turbine engine/fleet operation, maintenance or repair, and also storing one or more predetermined application rules for use by said server, wherein said server implements a rules/reasoner engine that applies one or more of said domain knowledge models for evaluating acquired gas turbine engine operational condition data, gas turbine engine/fleet historical data and/or gas turbine engine specific information, and wherein said implemented rules/reasoner engine further produces a workscope recommendation output based upon said predetermined information/knowledge models and application rules and said acquired gas turbine engine/fleet data and information.

20. The system of claim 19 further including at least one device for displaying or printing said workscope recommendation output.
